(19) United States
(12) Patent Application Publication
(10) Pub. No.: US 2026/0022695 A1
(43) Pub. Date: Jan. 22, 2026

(54) PUMP AND VALVE SYSTEM

(71) Applicant: Leggett & Platt Canada Co., Halifax (CA)

(72) Inventors: Krzysztof Zulauf, Windsor (CA); Horia Blendea, LaSalle (CA); Eric L. Baetens, Amherstburg (CA)

(21) Appl. No.: 19/274,274

(22) Filed: Jul. 18, 2025

Related U.S. Application Data
(60) Provisional application No. 63/673,001, filed on Jul. 18, 2024.
(60) Provisional application No. 63/718,378, filed on Nov. 8, 2024.

(51) Int. Cl. F04B 49/03; B60N 2/66; F04B 45/04; F04B 49/06

(52) U.S. Cl. CPC F04B 49/03; F04B 45/043; F04B 49/065; B60N 2/665

(57) ABSTRACT

A pneumatic pump includes a housing including a plurality of outlet ports. A pneumatic pump may include a motor extending along a longitudinal axis. A pneumatic pump may include a pneumatic pump driven by the motor. A pneumatic pump may include a valve assembly downstream of the pneumatic pump and in fluid communication with the plurality of outlet ports, the valve assembly configured to selectively direct an airflow generated by the pneumatic pump to the plurality of outlet ports. A pneumatic pump may include a printed circuit board supported by the housing and electrically connected to the motor and the valve assembly, wherein the printed circuit board extends parallel to the longitudinal axis.

### CROSS-REFERENCE TO RELATED APPLICATIONS

The present application claims priority to U.S. Provisional Patent Application No. 63/673,001, filed Jul. 18, 2024, and to U.S. Provisional Patent Application No. 63/718,378, filed Nov. 8, 2024, the entire contents of both of which are incorporated herein by reference.

### TECHNICAL FIELD

The present disclosure relates to a pump and valve system for use within vehicle seating systems (aircraft, automobiles, etc.).

### BACKGROUND

Vehicle seating systems may include pneumatic bladders to provide adjustable lumbar support, seat firmness, bolster spacing, and the like. Pneumatic bladders may also be inflated and deflated in patterns to produce a massaging effect. Such systems require a source of pressurized air, typically in the form of a motor-driven air pump, and a valve system for directing pressurized air from the source to the various bladders, thereby controlling inflation and deflation of the bladders.

The source of pressurized air and the valve system both require power and electronics to control and operate. These components must all be mounted within the relatively limited space available within the vehicle seating system. In addition, the source of pressurized air and the valve system typically produce noise, generated, for example, by operating the motor and pump, actuating the valve system, and exhausting air from the bladders to the environment. As vehicles become quieter, particularly electric vehicles, such noise becomes more evident. However, to provide more feature-rich seating systems including, for example, more levels of adjustment and more pronounced massage effects, more airflow is needed. More airflow typically means larger and noisier pumps and valves. Accordingly, airflow, noise, and size/complexity are competing factors in the design of vehicle seating systems with pneumatic bladders.

### SUMMARY

Accordingly, a need exists for a more compact pump and valve system for use within vehicular seating systems to consolidate or reduce the overall footprint of the inflation device that inflates various seating air bladders. A further need exists for such a pump and valve system with low noise output and a high air volume output.

The present disclosure provides, in some aspects, a configuration for a pump and a method of pumping air from a pump into a valve assembly. As described in greater detail below, the pump and valve assembly are coupled together to form a compact design. The resulting pump assembly may be advantageously used in applications of the pneumatic bladder system (e.g., in vehicle seats, massage chairs, etc.) where a compact design is desirable.

For example, in some aspects, the techniques described herein relate to a pump assembly including: a housing including a plurality of outlet ports; a motor extending along a longitudinal axis; a pneumatic pump driven by the motor; a valve assembly downstream of the pneumatic pump and in fluid communication with the plurality of outlet ports, the valve assembly configured to selectively direct an airflow generated by the pneumatic pump to the plurality of outlet ports; a printed circuit board supported by the housing and electrically connected to the motor and the valve assembly, wherein the printed circuit board extends parallel to the longitudinal axis.

In some aspects, the techniques described herein relate to a pump assembly including: a housing including a plurality of outlet ports; a motor extending along a longitudinal axis; a pneumatic pump driven by the motor; a valve assembly downstream of the pneumatic pump and in fluid communication with the plurality of outlet ports, the valve assembly configured to selectively direct an airflow generated by the pneumatic pump to the plurality of outlet ports; a printed circuit board supported by the housing and electrically connected to the motor and the valve assembly, wherein pump assembly is configured to output an airflow at a free flow rate between 3-6 liters per minute, and wherein the pump assembly is operable at a maximum loudness between 1.1 sones and 1.2 sones.

In some aspects, the techniques described herein relate to a pump assembly including: a housing including a plurality of outlet ports; a motor extending along a longitudinal axis; a pneumatic pump driven by the motor; a valve assembly downstream of the pneumatic pump and in fluid communication with the plurality of outlet ports, the valve assembly configured to selectively direct an airflow generated by the pneumatic pump to the plurality of outlet ports; and a printed circuit board supported by the housing and electrically connected to the motor and the valve assembly, wherein the valve assembly includes a first control valve, a second control valve arranged in series with the first control valve, a third control valve arranged in parallel with the first and second control valves, and a fourth control valve arranged in series with the third control valve. Other aspects of the disclosure will become apparent by consideration of the detailed description and accompanying drawings.

### BRIEF DESCRIPTION OF THE DRAWINGS

FIG. 1 is a perspective view of an embodiment of a pump assembly according to an embodiment of the present disclosure.

FIG. 2 is a schematic illustration of a pneumatic system according to the present disclosure, including the pump assembly of FIG. 1.

FIG. 3 is an exploded view of the pump assembly of FIG. 1, illustrating a pneumatic pump and a valve assembly.

FIG. 4 is a cross-sectional view along a centerline of the pump assembly of FIG. 1, illustrating an airflow being generated by the pneumatic pump and directed by the valve assembly.

FIG. 5 is an enlarged cross-sectional view of the pump assembly of FIG. 4, illustrating a solenoid valve of the valve assembly in an open position.

FIG. 6 is another cross-sectional view along a centerline of the pump assembly of FIG. 1, illustrating the pneumatic pump driven by a motor.

FIG. 7 is a perspective view of a pump assembly in accordance with another embodiment of the disclosure.

FIG. 8 is an exploded view of the pump assembly of FIG. 7, illustrating a pneumatic pump and a valve assembly.

FIG. 9 is a schematic diagram of the pump assembly of FIG. 7, illustrating an airflow being directed to a plurality of air bladders.

FIG. 10 is a cross-sectional view along a centerline of the pump assembly of FIG. 7, illustrating an airflow being generated by the pneumatic pump and directed by the valve assembly to some of the plurality of air bladders.

FIG. 11 is a cross-sectional view along a centerline of the pump assembly of FIG. 7, illustrating an airflow being generated by the pneumatic pump and directed by the valve assembly to some other of the plurality of air bladders.

FIG. 12 is an enlarged cross-sectional view of the pump assembly of FIG. 7, illustrating a solenoid valve of the valve assembly in an open position.

FIG. 13 is an enlarged cross-sectional view of the pump assembly of FIG. 7, illustrating another solenoid valve of the valve assembly in an open position.

FIG. 14 is a perspective view of a pump assembly in accordance with another embodiment of the disclosure.

FIG. 15 is a table reflecting data obtained during testing of the pump assembly of FIGS. 1, 7, and 14.

FIG. 16 is a graph reflecting data obtained during testing of the pump assembly of FIGS. 1, 7, and 14.

FIG. 17 is another graph reflecting data obtained during testing of the pump assembly of FIGS. 1, 7, and 14 during various stages of operation.

FIG. 18 is a perspective view of a pump assembly according to another embodiment of the disclosure.

FIG. 19 is an exploded view of the pump assembly of FIG. 18.

FIG. 20 is a schematic view of a pneumatic system including the pump assembly of FIG. 18.

FIG. 21 is an enlarged cross-sectional view of the pump assembly of FIG. 18, with solenoid valves of the pump assembly in a first inflation configuration.

FIG. 22 is an enlarged cross-sectional view of the pump assembly of FIG. 18, with the solenoid valves in a second inflation configuration.

FIG. 23 is an enlarged cross-sectional view of the pump assembly of FIG. 18, with the solenoid valves in a first deflation configuration.

FIG. 24 is another enlarged cross-sectional view of the pump assembly of FIG. 18, with the solenoid valves in the second inflation configuration.

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways. Also, it is to be understood that the phraseology and terminology used herein is for the purpose of description and should not be regarded as limiting. In addition, as used herein, the terms “upper”, “lower”, and other directional terms are not intended to require any particular orientation but are instead used for purposes of description only.

### DETAILED DESCRIPTION

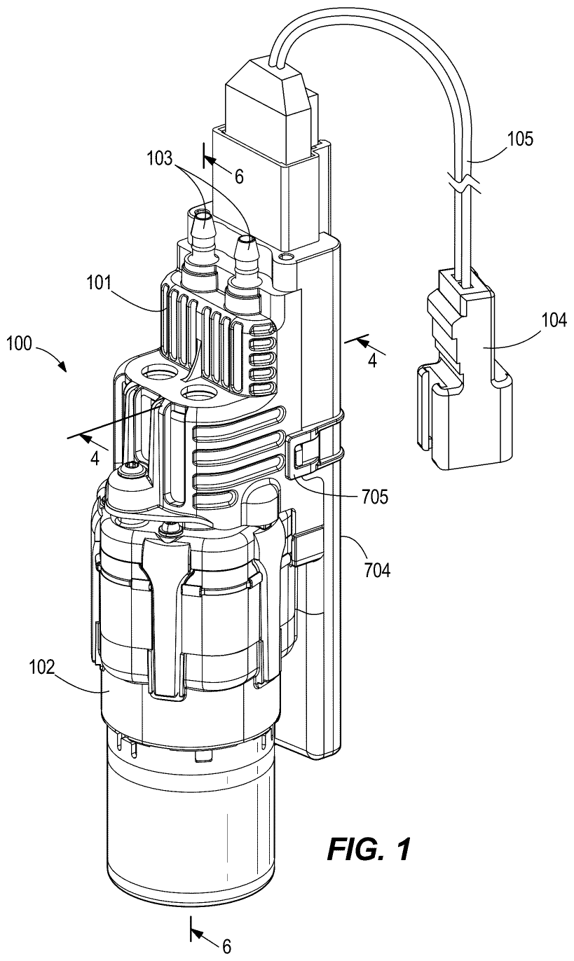

FIG. 1 illustrates a pump assembly 100 according to an embodiment of the present disclosure. In one embodiment, the pump assembly 100 is configured for providing air for use in an application, for example in an automotive application. Such air is provided from the pump assembly 100 through one or more of a plurality of outlet ports 103. The pump assembly 100 may include a pump configured to run (i.e., pump air through the plurality of outlet ports 103) using an electrical connection 105, which may supply electric power to the pump assembly 100. The electrical connection 105 may, through the use of a connector 104, be connected to a power source.

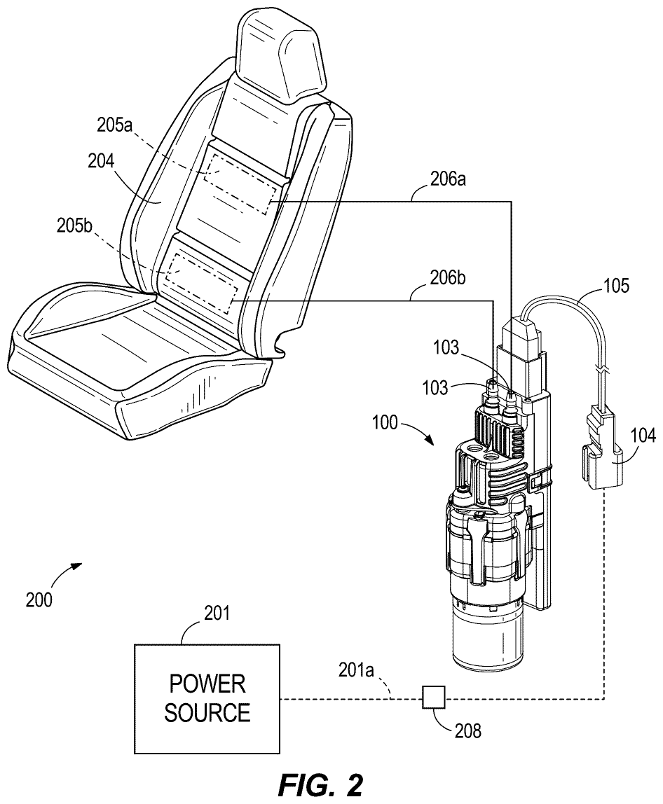

FIG. 2 illustrates an embodiment of a pneumatic system 200 including the pump assembly 100. The pneumatic system 200 may be a portion of an automobile. For example, in the illustrated embodiment, the pneumatic system 200 is part of an automobile seating assembly. Other applications of the pneumatic system 200 are contemplated, however, such as aerospace applications, office/desk chair applications, or the like.

In the illustrated embodiment, the pneumatic system 200 includes a power source 201, which may be part of an electrical power system of an automobile. The connector 104 is configured to connect to the power source 201. As such, the power source 201 may supply power 201a (e.g., at 12 Volts or 24 Volts in some embodiments) through the electrical connection 105 and to the pump assembly 100 via the connector 104.

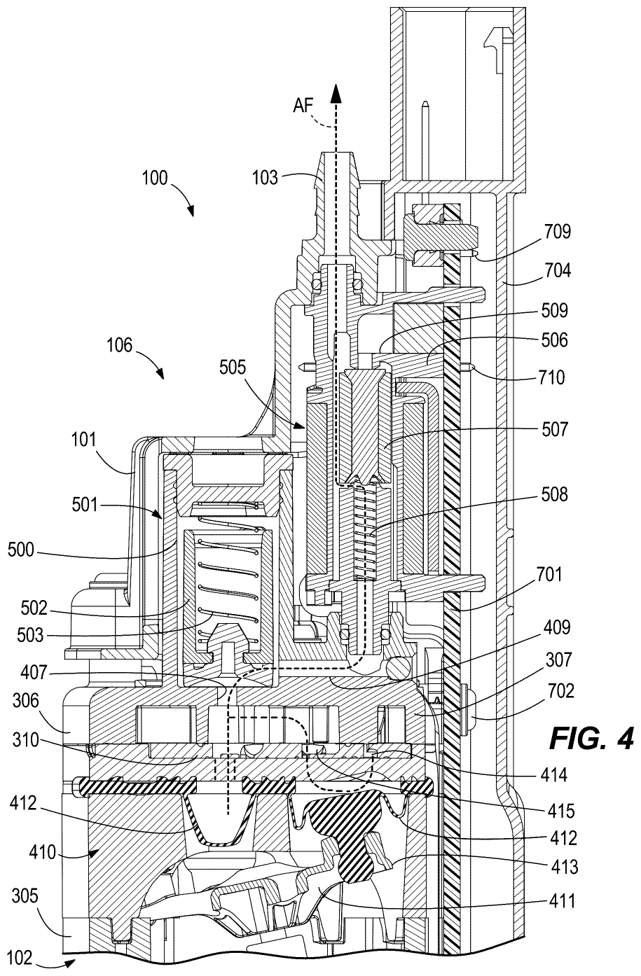

When the pump assembly 100 is powered, the pump assembly 100 may operate to pump an airflow AF through the plurality of outlet ports 103. The airflow AF may travel from one or more of the outlet ports 103 through respective pneumatic lines 206a, 206b. The pump assembly 100 further includes a valve assembly 106 (FIG. 4) that may serve to: (i) direct air along the pneumatic lines 206a, 206b from the pump assembly 100, (ii) interrupt a flow of air along the pneumatic lines 206a, 206b directed from the pump assembly 100, (iii) regulate pressure of a flow of air through the pneumatic lines 206a 206b, and/or (iv) regulate flow rate of a flow of air through the pneumatic lines 206a, 206b. The pump assembly 100 and the valve assembly 106 thus define an integrated pump and valve system.

The pneumatic lines 206a, 206b may be connected to respective bladders 205a, 205b. The bladders 205a, 205b may be configured to expand or contract as the airflow AF from the pneumatic lines 206a, 206b flows into or out from the bladders 205a, 205b. In one embodiment, the bladders 205a, 205b may be supported in a bladder supporting device 204. In some embodiments, the bladder supporting device 204 is a seat configured to be positioned within an automobile. For example, the bladder 205b is positioned within the bladder supporting device 204 to provide lumbar support when a user sits in the seat against the bladder supporting device 204. In such an embodiment, the user may request increasing or decreasing lumbar support (e.g., the user may press a button 208) which, in the case of increasing lumbar support, require activation of the pump assembly 100 to provide the airflow AF from the pump assembly 100, through the pneumatic line 206b, and into the bladder 205b (the lumbar bladder) thereby inflating the bladder 205b and providing the requested lumber support. Similarly, the user may increase or decrease thoracic support by inflating or deflating the bladder 205a via the user pressing the same or a different button (or other suitable actuator).

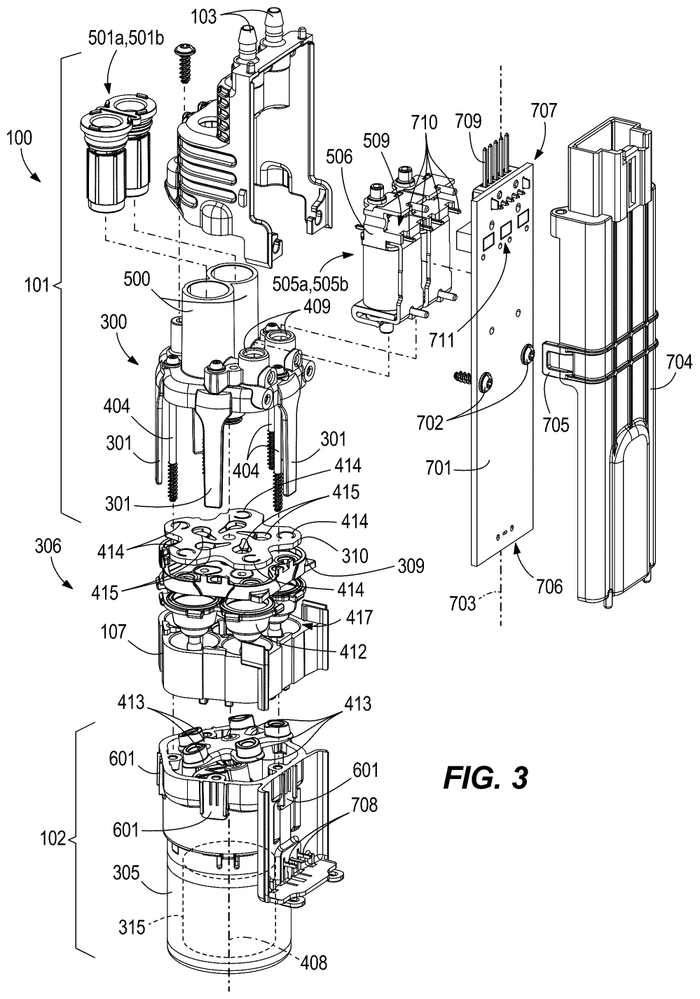

FIG. 3 illustrates an exploded view of the pump assembly 100. The pump assembly 100 extends along a longitudinal axis 408 and includes an upper casing 101, a lower casing 102, and a pump housing 107 between the upper and lower casings 101, 102. The upper casing 101 includes the plurality of outlet ports 103 in the illustrated embodiment and also includes a coupling structure 300 configured to engage the lower casing 102 and couple the upper casing 101 and the lower casing 102 together. In the illustrated embodiment, the coupling structure 300 includes four fingers 301 positioned equidistantly around a circumference of the upper casing 101. Each of the fingers 301 engages a corresponding receiving portion, for example receiving portions 601 (there are four total but only three of which are shown in FIG. 3). As such, to connect the upper casing 101 with the lower casing 102, the fingers 301 may engage (e.g., by clipping into) the receiving portions 601. In the illustrated embodiment, a plurality of screws 404 extends through the upper casing 101 in a direction parallel to the longitudinal axis 408 and threads into the lower casing 102 to secure the casings 101, 102 together and clamp the pump housing 107 between the upper and lower casings 101, 102. The fingers 301 and screws 404 are positioned in an alternating manner around the circumference of the upper casing 101 in the illustrated embodiment. In other embodiments, the upper and lower casings 101, 102 may be coupled together in other ways or may be formed as a single, unitary casing.

With reference to FIGS. 3 and 4, the illustrated pump assembly 100 includes a head plate 309 and a valve plate 310 positioned between the upper casing 101 and the lower casing 102 and, more specifically, between the pump housing 107 and the upper casing 101. A diaphragm assembly 417, which forms part of a pneumatic pump 410 described in greater detail below, is clamped between the head plate 309 and the pump housing 107. The valve plate 310 includes a plurality of air intake valves 414 and a plurality of air outlet valves 415 to control the airflow AF into and out of the diaphragm assembly 417, as the diaphragm assembly 417 is sequentially compressed and expanded during operation of the pneumatic pump 410. One air intake valve 414 and one air outlet valve 415 is aligned with each respective diaphragm cup 412 of the diaphragm assembly 417. The air intake valves 414 and the air outlet valves 415 may be one-way reed valves integrally formed together with the valve plate 310. The valve plate 310 may be composed of rubber or another suitable resilient elastomeric material. In other embodiments, the valve plate 310 may include other types of one-way valves.

The upper casing 101 includes an outlet plate 307 positioned adjacent to the valve plate 310 (FIG. 4). The outlet plate 307 includes passages for communicating each of the air intake valves 414 with an air intake of the pneumatic pump 410 (e.g., a passageway through the upper casing 101 that communicates with the outside environment) and passages for communicating each of the air outlet valves 415 with a pair of outlets 407 (one of which is illustrated in FIG. 4). In the illustrated embodiment, each of the outlets 407 leads to a respective check valve chamber 500. As described in greater detail below, airflow generated by the pump assembly 100 is discharged through the outlets 407 before being ultimately directed to one or more of the plurality of outlet ports 103.

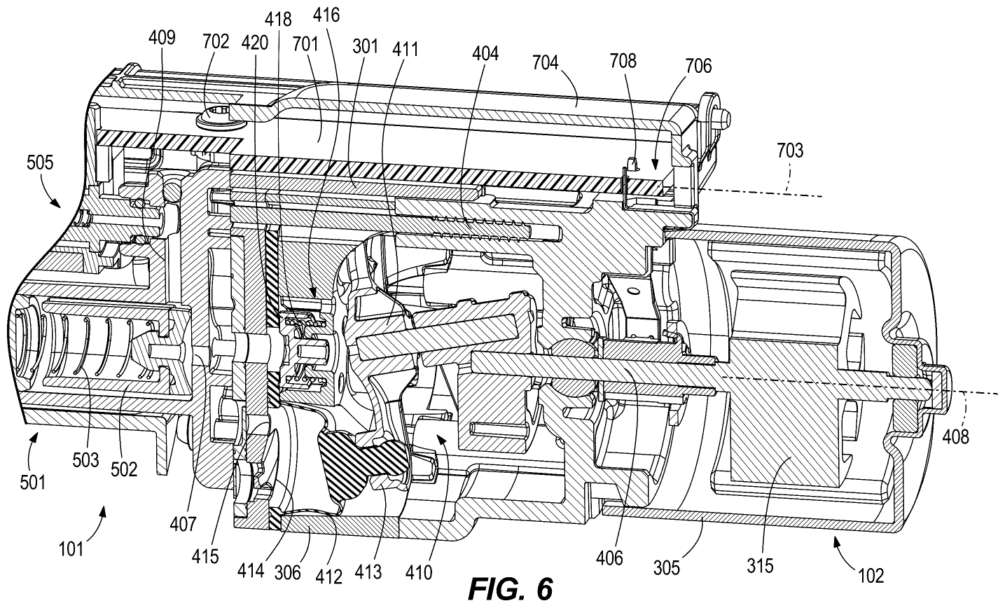

With continued reference to FIGS. 3-4, the illustrated pump assembly 100 further includes a lower pump assembly 305 that is connected to an upper pump assembly 306. A drive interface 406 (FIG. 6) may provide electrical and/or mechanical communication between the lower pump assembly 305 and the upper pump assembly 306. For example, the illustrated lower pump assembly 305 includes an electrical motor 315 extending along the longitudinal axis 408 that drives the drive interface 406 about the axis 408, and the upper pump assembly 306 includes the pneumatic pump 410, which is coupled to the drive interface 406. In such an embodiment, the drive interface 406 provides rotational energy (for example, via a driveshaft) to the upper pump assembly 306 to drive the pneumatic pump 410 contained therein.

More specifically, in the illustrated embodiment, the drive interface 406 includes a driveshaft coupled to an eccentric crank, which in turn is coupled to a wobble plate 411 that sequentially actuates a plurality of chambers or diaphragm cups 412 one after another as the wobble plate 411 oscillates about the longitudinal axis 408. The wobble plate 411 has a plurality of arms 413, where each arm 413 is coupled to a respective diaphragm cup 412 (FIGS. 4, 6). Due to the oscillating nature of the wobble plate 411, each arm 413 of the wobble plate 411 pushes and pulls the respective diaphragm cup 412 continuously and sequentially 412 to draw the airflow AF into and discharge the airflow AF out of the diaphragm cup 412 (FIG. 4). When one of the diaphragm cups 412 is pulled by the respective arm 413, the airflow AF is drawn in through the corresponding one of the plurality of air intake valves 414 (FIG. 3) and into the diaphragm cup 412. Subsequently, when the diaphragm cup 412 is pushed by the respective arm 413, the compressed airflow AF is discharged from the diaphragm cup 412 and through the corresponding one of the air outlet valves 415 (FIG. 3). The airflow AF that is discharged from each diaphragm cup 412 ultimately exits the upper pump assembly 306 via the outlets 407 in the outlet plate 307. In the illustrated embodiment, the wobble plate 411 includes five arms 413 that are connected to five chambers or diaphragm cups 412. This arrangement provides efficient packing and a greater amount of volume in the diaphragm cups 412 than other arrangements (e.g., diaphragm assemblies having 2, 3, or 4 diaphragm cups), enabling a higher flow rate of the pneumatic pump 410 for a given operating speed of the motor 315 than such other arrangements. When a lower amount of airflow is needed, the motor 315 can be driven more slowly compared to pumps with other diaphragm arrangements, which may result in power savings, reduced noise, and improved longevity in some embodiments. In other embodiments, the wobble plate 411 may include a greater number of arms and diaphragm cups.

FIG. 6 illustrates a pressure relief valve 416 disposed within the upper pump assembly 306 that serves to release excess pressure delivered to the valve assembly 106 from the pneumatic pump 410 and thereby reduce potential wear on the pneumatic pump 410. The pressure relief valve 416 is in fluid communication with the two upper assembly outlets 407 on the discharge side of the pneumatic pump 410. The illustrated pressure relief valve 416 includes a sealing ram 418 and a ram spring 420 biasing the sealing ram 418 towards a closed position. When the sealing ram 418 is in the closed position (as shown in FIG. 6), any airflow AF generated by the pneumatic pump 410 is sent through both of the upper assembly outlets 407 in the outlet plate 307 and toward the check valves 501 associated with the respective outlets 407. However, if excess pressure builds up downstream of the pneumatic pump 410 (e.g., due to the check valves 501 becoming stuck, due to increased pressure downstream of the check valves 501 from weight compressing the bladders 205a, 205b, etc.), the pressure exerts a force on the sealing ram 418 that overcomes the bias of the ram spring 420 to move the sealing ram 418 to an open position. When the sealing ram 418 moves to the open position, air may be vented past the sealing ram 418 and into the lower casing 102 (which communicates with the surrounding atmosphere), thereby reducing the pressure downstream of the pneumatic pump 410. When the excess pressure is relieved, the sealing ram 418 is urged back to the closed position via the ram spring 420. In other embodiments, the pressure relief valve 416 may have other configurations (e.g., an elastomeric reed valve or umbrella valve, etc.). In yet other embodiments, the pressure relief valve 416 may be omitted.

As previously mentioned, the pneumatic pump 410 pumps the compressed airflow AF through both of the upper assembly outlets 407 in the outlet plate 307 and toward the check valves 501a, 501b (FIG. 3). The two check valves 501a, 501b are identical in nature-one downstream each of the upper assembly outlets 407—but only one will be described in further detail below for sake of brevity and conciseness.

With continued reference to FIG. 4, the check valve 501 is aligned with the upper assembly outlet 407 and oriented parallel to the longitudinal axis 408. The check valve 501 includes a valve body 502 and a spring 503 biasing the valve body 502 to a closed position. When the check valve 501 is in the closed position (as shown in FIG. 4), the valve body 502 covers the upper assembly outlet 407, such that the airflow AF is inhibited from passing through the check valve 501. When the motor 315 activates, the airflow AF discharged from the diaphragm cups 412 creates a sufficient pressure to overcome the bias of the spring 503, causing the check valve 501 to move to an open position. When the check valve 501 is in the open position, the valve body 502 is pushed upward against the bias of the spring 503 to enable an airflow AF to pass beyond the check valve 501 and towards a control valve 505. The airflow AF travels through an air passageway 409 that is disposed between the check valve 501 and the control valve 505.

There are two control valves 505a, 505b-one downstream from each check valve 501a, 501b in the illustrated embodiment. The two check valves 501a, 501b and the two control valves 505a, 505b are arranged in parallel with respect to each other (not in series), such that air generated from the displacement of the diaphragm cups 412 can pass simultaneously and independently through the two check valves 501a, 501b and the two control valves 505a, 505b. Only one control valve 505 will be described for sake of brevity and conciseness.

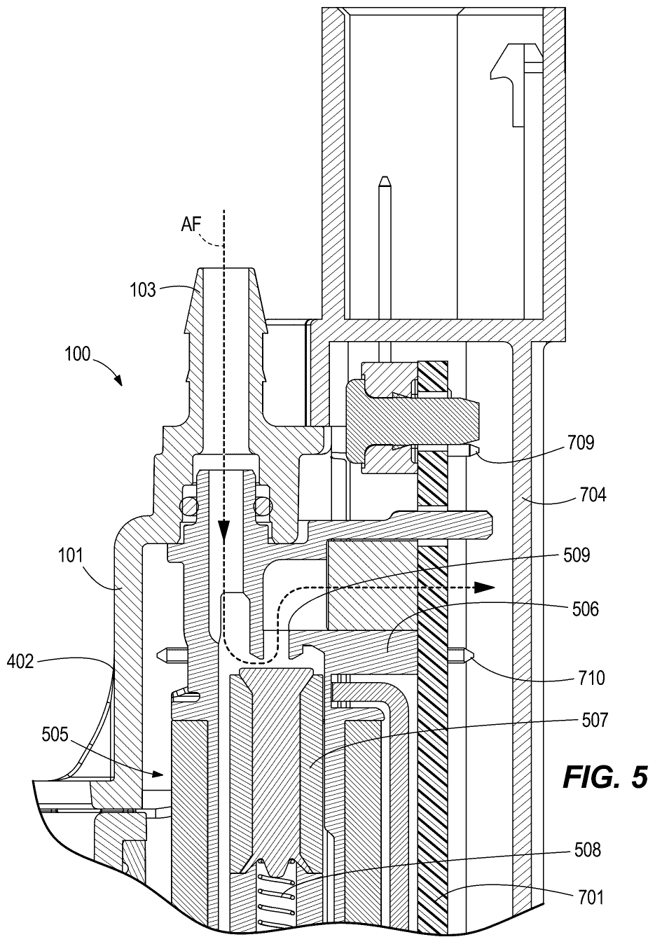

The illustrated control valve 505 is a 3/2-way solenoid-actuated directional control valve and is oriented parallel to the longitudinal axis 408. The control valve 505 is also located downstream of the check valves 501. The control valve 505 includes a housing 506 and a plunger 507. When the control valve 505 is unenergized, the plunger 507 is biased towards an inflating position (FIG. 4) via a spring 508, thereby allowing the airflow AF to pass through the control valve 505. As such, the airflow AF from the check valve 501 flows through the control valve 505 and directed to an associated one of the outlet ports 103 (e.g., to inflate a connected bladder 205a, 205b). In contrast, when the control valve 505 is energized, the plunger 507 is moved to a deflating position (FIG. 5) against the bias of the spring 508, thereby preventing the airflow AF passing through the control valve 505. Simultaneously, the airflow AF (if any) from the bladder 205a, 205b associated with the outlet port 103 is allowed to exit through an exhaust port 509 of the control valve 505 to the environment. In the embodiment shown in FIG. 5, a filter (e.g., open-cell foam) is positioned between the exhaust port 509 and the environment to reduce noise produced by the outgoing airflow.

Although the illustrated control valve 505 is a solenoid valve, it should be understood that other control valves 505 may be used, including valves with other types of actuators. For example, the control valve 505 may include a shape-memory alloy actuator configured to expand or contract to move the plunger 507.

With reference to FIGS. 3 and 4, the pump assembly 100 further includes a printed circuit board (or PCB) 701. The PCB 701 is coupled alongside the upper casing 101 and the lower casing 102, and more particularly, coupled via a pair of fasteners 702 to an outer periphery of the upper casing 101. The PCB 701 is mounted to the casings 101, 102 in an orientation to be parallel to the longitudinal axis 408 in the illustrated embodiment. That is, the PCB 701 includes a longitudinal axis 703 extending along the length of the PCB 701 and the longitudinal axis 703 is parallel to the longitudinal axis 408. A PCB housing 704 is coupled to the casings 101, 102 via a plurality of quick-connect tabs 705. The PCB housing 704 encases the PCB 701 to prevent unwanted ingress of debris and protect the PCB 701 from inadvertent damage. The upper casing 101, the lower casing 102, the pump housing 107, and the PCB housing 704 may collectively define a housing of the pump assembly 100 and may be referred to herein as portions of the housing of the pump assembly 100. In some embodiments, one or more of the upper casing 101, the lower casing 102, the pump housing 107, and the PCB housing 704 may be integrally formed together, and the housing of the pump assembly 100 may otherwise be configured in various ways.

The PCB 701, at a bottom end 706, is adjacent the motor 315 and, at a top end 707, adjacent the upper casing outlet ports 103, such that the PCB 701 extends between the motor 315 and the upper casing outlet ports 103. Motor pins 708 extends from the motor 315 and engage the PCB 701 at the bottom end 706. Similarly, power pins 709 extend from the connector 104 and engage the PCB 701 at the top end 707. Also, valve pins 710 extend from the housing 506 of the control valve 505 and engage the PCB 701 between the top end 707 and the bottom end 706. The pins 708, 709, 710 enable the PCB 701 to communicate with the various components (e.g., the motor 315, the solenoid valves 505, etc.) of the pump assembly 100. The PCB 701 may also include one or more heat generating electronic components 711 (e.g., MOSFETs, resistors, transistors, capacitors, inductors, sensors) that may be aligned with the exhaust port 509 to dissipate heat away from the heat generating electronic components 711. The PCB 701 may also include a microcontroller or microprocessor that is configured to monitor various characteristics (e.g., status of solenoid valves, etc.) of the pneumatic system 200.

In operation, an occupant of seat may request increasing or decreasing, for example, lumbar support (e.g., the user may press the button 208) which, in the case of increasing lumbar support, would require activation of the pump assembly 100 to provide air from the pump assembly 100, through the pneumatic line 206b, and into the bladder 205b (the lumbar bladder) positioned within the bladder supporting device 204, thereby inflating the bladder 205b and providing the requested lumber support. Specifically, the motor 315 is activated to begin filling the air bladder 205b by supplying air from the pump assembly 100 and through the pneumatic line 206b. As shown in FIG. 4, when the motor 315 is activated to drive the pneumatic pump 410, the diaphragm cups 412 draw air in through the plurality of air intake valves 414 and discharge the airflow AF through the upper assembly outlets 407. By default, the check valves 501 and the pressure relief valve 416 are in the closed position, but the airflow AF exiting the upper assembly outlet 407 provide sufficient force to overcome the biasing force of the spring 503 to move the valve body 502 away from the outlet 407. As such, the check valves 501 move to the open position and the airflow AF passes through the air passageway 409 toward the control valves 505. Subsequently, the airflow AF passes around the unenergized control valve 505b (i.e., in the inflating position), out the upper assembly outlet port 103, through the pneumatic line 206b, and into the air bladder 205b.

If, for example, the airflow AF cannot pass beyond the check valve 501 because the air bladder 205b is completely full, excess pressure may build up in the valve assembly 106 and the airflow AF may discharge through the pressure relief valve 416. Once the air bladder 205b is inflated properly, the motor 315 is deactivated and the check valve 501b, in response, moves to the closed position via bias of the spring 503. As a result, the air bladder 205b is inhibited from deflating because the check valve 501b is in the closed position. To deflate the bladder 205b, the PCB 701 sends an electrical signal to the control valve 505b via the valve pins 710, causing the plunger 507 to move to the deflating position (FIG. 5). With the solenoid valve 505b in the deflating position, air exits from the air bladder 205b, along the pneumatic line 206b, and out the exhaust port 509 to the environment.

If the other air bladder 205a is to be supplied with the airflow AF, the control valve 505a is in the closed position, such that the airflow AF passes beyond the control valve 505a and along the pneumatic line 206a toward the air bladder 205a to be filled. To avoid filling, for example, the air bladder 205b, the associated solenoid valve, such as solenoid valve 505b remains in the deflating position, such that airflow AF is blocked from reaching the bladder 205b and air currently present in the bladder 205b is discharged through the outlet port 103 and the exhaust port 509.

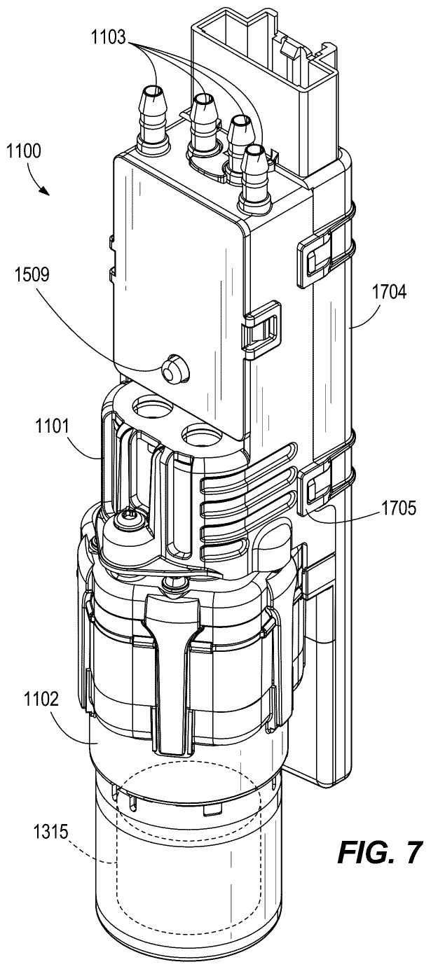

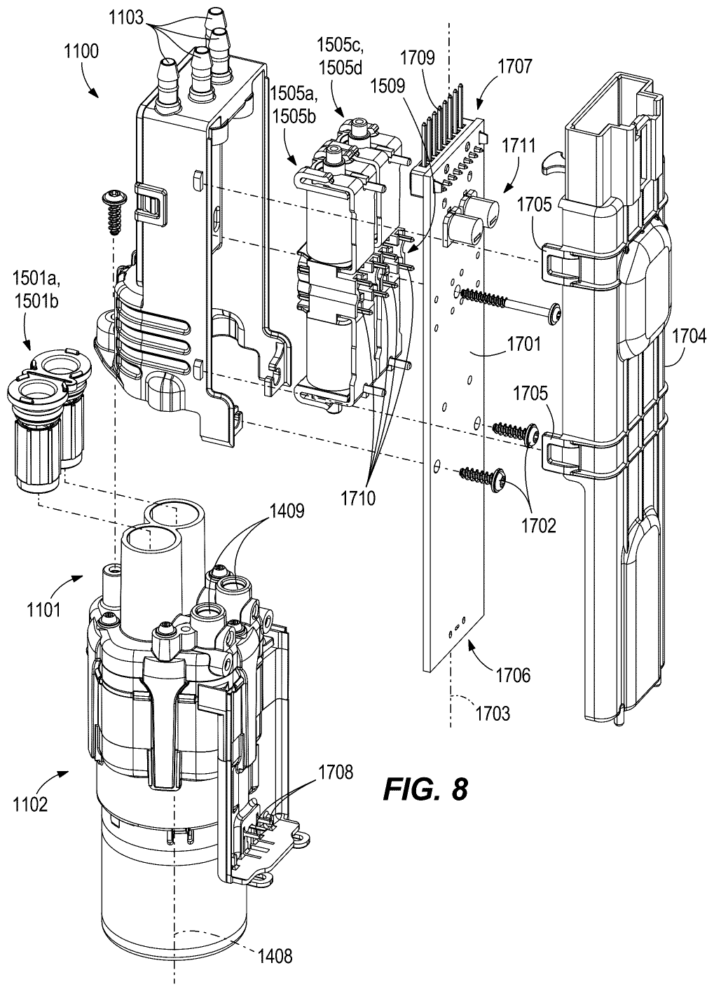

FIGS. 7 and 8 illustrate a pump assembly 1100 according to another embodiment. The pump assembly 1100 is similar to the pump assembly 100 described above with reference to FIGS. 1-6, and features and elements of the pump assembly 1100 corresponding with features and elements of the pump assembly 100 are given identical reference numbers plus 1000. In addition, the following description focuses primarily on differences between the pump assembly 1100 and the pump assembly 100.

With reference to FIGS. 7 and 8, the illustrated pump assembly 1100 includes two pairs of control valves for a total of four control valves 1505a, 1505b, 1505c, 1505d instead of two control valves 505a, 505b. As described in greater detail below, the control valves 1505a, 1505c provide inflation and deflation control, and the control valves 1505b, 1505d provide port selection (directional) control. That is, the control valves 1505b, 1505d select which of the bladders 1205a-d are fluidly connected to the pump assembly 1100, and the control valves 1505a, 1505c control whether the selected bladders 1205a-d are inflated or deflated.

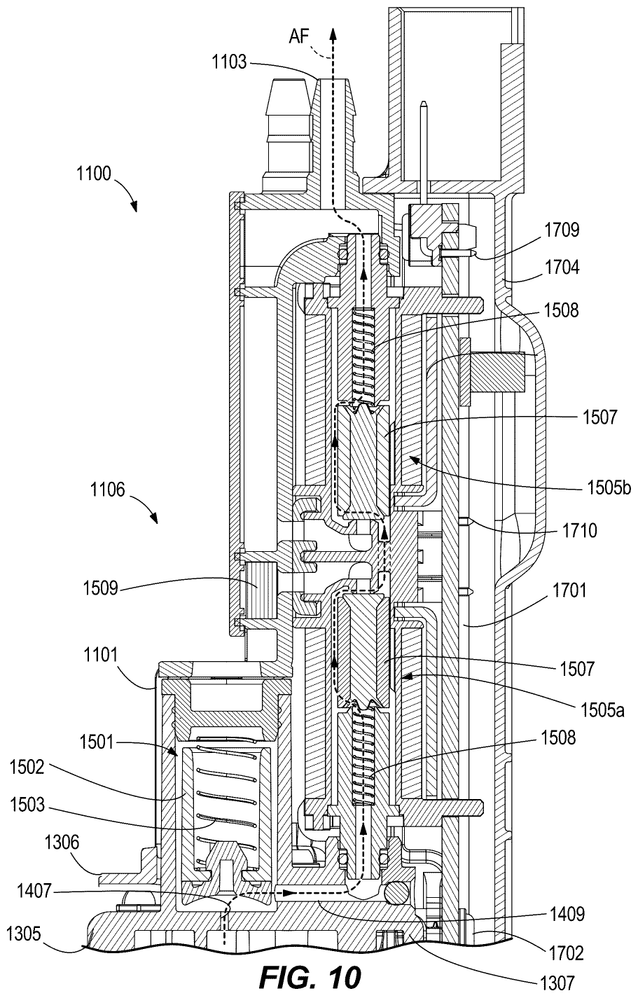

In the illustrated embodiment, the pair of control valves 1505a, 1505b is arranged in parallel with respect to the other pair of control valves 1505c, 1505d (not in series). That is, the individual control valves comprising each pair of valves are arranged in series such that control valves 1505a, 1505b are arranged in series with each other and the control valves 1505c, 1505d are arranged in series with each other (FIGS. 8-10). As such, air generated from the diaphragm cups 1412 can pass simultaneously and independently through each pair of control valves after passing through the respective check valves 1501a, 1501b. That is, the check valve 1501a is upstream of the pair of control valves 1505a, 1505b and the check valve 1501b is upstream of the pair of control valves 1505c, 1505d (FIG. 10).

The control valves 1505a, 1505b, 1505c, 1505d are oriented parallel to the longitudinal axis 1408. Similarly, the PCB 1701 defines a longitudinal axis 1702 that is oriented parallel to the longitudinal axis 1408. Each control valve 1505a-1505d is a 3/2-way pneumatic directional control valve in the illustrated embodiment. Downstream of each pair of control valves 1505a, 1505b, 1505c, 1505d is a plurality of air bladders, totaling four air bladders 1205a, 1205b, 1205c, 1205d. The pump assembly 1100 may also include the pressure relief valve 416 that allows the airflow AF to discharge from the pump assembly 1100 if there is excess pressure.

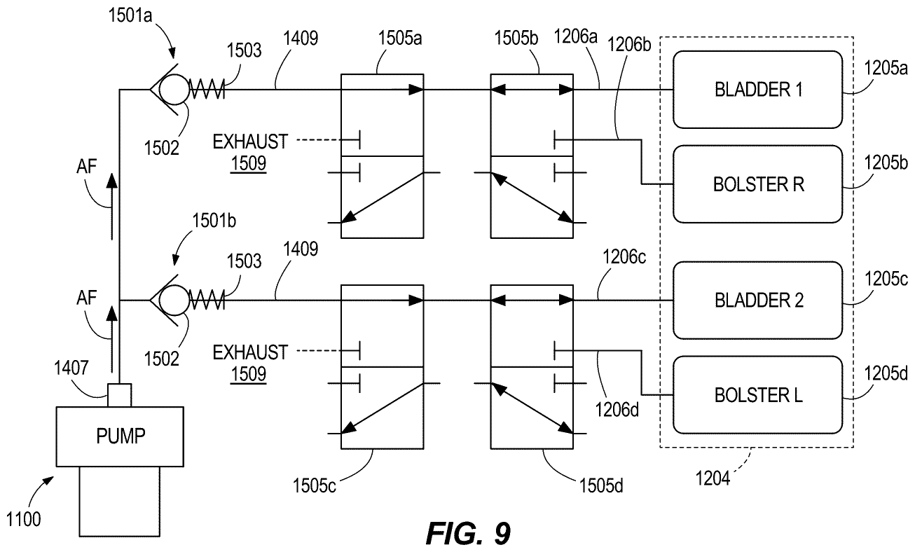

In operation, an occupant of seat may desire to inflate or deflate (i.e., increase or decrease air pressure), for example, bladders 1 and 2 1205a, 1205c. To obtain additional support from bladders 1 and 2, the motor 1315 of the pump assembly 1100 is activated to provide the airflow AF from the pump assembly 1100, through the pneumatic line 1206a, 1206c and into the bladders 1205a, 1205c (i.e., bladders 1 and 2) to inflate them. Prior to activation of motor 1315, by default, the check valves 1501a, 1501b are in the closed position. However, when motor 1315 is activated, the airflow AF exiting the upper assembly outlet 1407 provides sufficient force to overcome the biasing force of the springs 1503 to move the valve bodies 1502 away from and open the outlet 1407 (FIG. 10). As such, the check valve 1501a, 1501b are in the open position so that airflow AF passes through respective air passageways 1409 toward the control valves 1505a, 1505c. Subsequently, with continued reference to FIGS. 9 and 10, the airflow AF passes through the unenergized control valves 1505a, 1505c (i.e., in the inflating position), through the unenergized control valves 1505b, 1505d, out two of the upper assembly outlet ports 1103, through the pneumatic lines 1206a, 1206c, and into the air bladders 1205a, 1205c. If, for example, the airflow AF cannot pass beyond the check valve 1501a, 1501b because the air bladders 1205a, 1205c are completely full, excess pressure may build up and the airflow AF may discharge through the pressure relief valve 416.

To inflate only one of the air bladders (e.g., air bladder 1205a), the control valve 1505c is energized, blocking the access of the airflow AF from reaching the bladder 1205c, and simultaneously allowing air present in the bladder 1205c to exit through the exhaust port 1509c. As evidenced, control valves 1505a, 1505c are responsible for inflating or deflating the air bladders, while the control valves 1505b, 1505d are responsible for directing the airflow AF towards specific air bladders (e.g., either bladders 1, 2 or bolsters R, L).

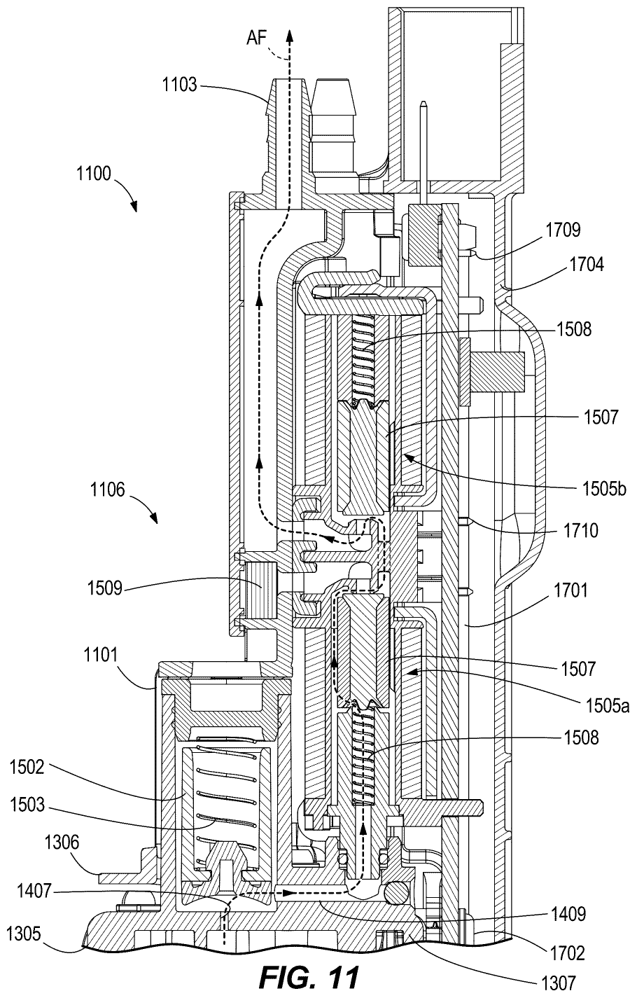

To inflate the bolsters 1205b, 1205d (FIGS. 9 and 11), the directional control valves 1505b, 1505d are energized. The air passes through the unenergized “inflating/deflating” control valves 1505a, 1505c, around the energized control valves 1505b, 1505d, out the other two upper assembly outlet ports 1103, through the pneumatic lines 1206b, 1206d, and into the air bladders 1205b, 1205d.

Once the air bladders 1205a, 1205b, 1205c, 1205d are inflated, the motor 1315 is deactivated and the check valves 1501a, 1501b, in response, move to the closed position via bias of the spring 1503. As a result, the air bladders 1205a, 1205c are inhibited from deflating because the check valves 1501a, 1501b and control valves 1505a and 1505c are in the closed position. Also, the bladders 1205b, 1205d are inhibited from deflating by the unpowered state of the control valves 1505a, 1505c.

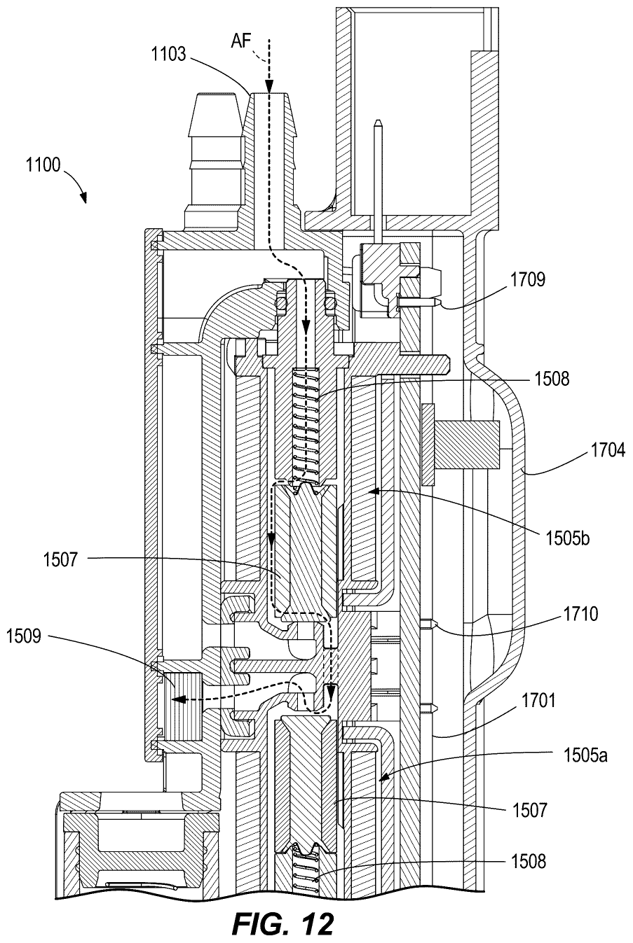

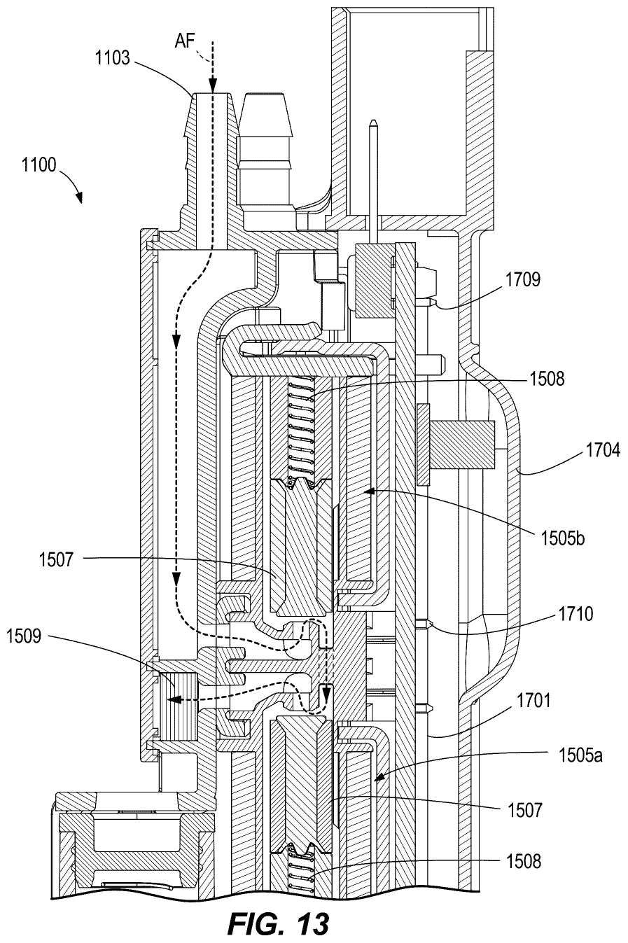

As shown in FIGS. 12 and 13, to deflate any one of the bladders 1205a, 1205b, 1205c, 1205d, motor 1315 remains inactivate and PCB 1701 sends an electrical signal to the “inflating/deflating” control valves 1505a, 1505c via the valve pins 1710, causing the control valves 1505a, 1505c to move to the open or deflating position. Specifically, with the control valves 1505a, 1505c in the open position and the control valves 1505b, 1505d in the closed position, the airflow AF exits from the air bladder 1205a, 1205c by flowing around unenergized control valves 1505b and 1505d and through energized (i.e., open) control valves 1505a and 1505c to the exhaust port 1509 and the environment.

Alternatively, in a similar manner, with the control valves 1505a, 1505c still in the open position and energizing the control valves 1505b, 1505d to the open position, the airflow AF exits from the air bladders 1205b, 1205d through the open control valves and to the exhaust port 1509 and the environment.

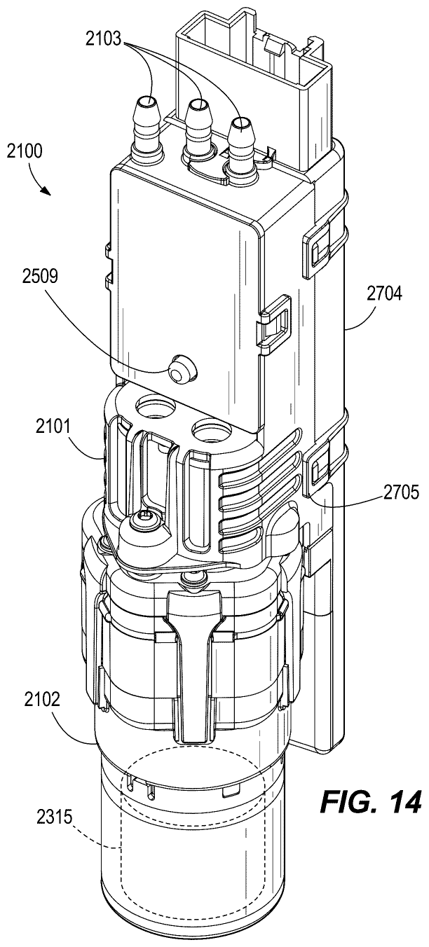

FIG. 14 illustrates a pump assembly 2100 according to another embodiment. The pump assembly 2100 is similar to the pump assembly 100 described above with reference to FIGS. 1-6, and features and elements of the pump assembly 2100 corresponding with features and elements of the pump assembly 100 are given identical reference numbers plus 2000. The primary difference between the pump assembly 2100 and the pump assembly 100 is the configuration of the control valves 2505 and the outlet ports 1103. Specifically, there are three outlets 1407 fluidly connected to and downstream of three control valves (not shown, but which may be similar to the control valves 1505a-c, for example).

Each of the control valves may be an inflation/deflation control valve associated with a respective one of the outlet ports 1103 to individually control inflation or deflation of a connected bladder. In such an embodiment, the pressure is held in the bladders by check valves (not shown, but which may be similar to the check valves 1501a, 1501b, for example), until it is desired to deflate the bladder, at which point the control valve associated with that bladder is moved to the deflation position.

In another embodiment, one of the control valves may be an inflation/deflation control valve, a second of the control valves may be a directional valve in series with the inflation/deflation control valve and coupled to two of the outlet ports 2103, and a third of the control valves may be an on/off valve in series with the inflation/deflation control valve and coupled to the remaining one of the outlet ports 2103. In such embodiments, the two bladders coupled to the directional valve may be inflated and deflated without inflating or deflating the third bladder that is coupled to the on/off valve. This may be advantageous if one bladder is configured as a lumbar support bladder and two bladders are arranged in the seatback or seat cushion to provide an alternating massage effect, for example.

It should be understood that other arrangements of control valves can also be incorporated into any of the assemblies described and illustrated herein to provide a desired functionality.

Various features of the pump assembly 100, 1100, 2100 described and illustrated herein advantageously contribute to quieter operation than known pump assemblies. For example, the five-diaphragm cup configuration (i.e., cups 412, 1412, 2412) allows the motor 315, 1315, 2315 to operate at a lower rotational speed while pumping a similar volume of air compared to pump assemblies with fewer diaphragm cups. Each pump assembly 100, 1100, 2100 may be configured to pump air at a free flow rate (with no connected bladders) of 3-6 liters per minute in some embodiments, or at least 4 liters per minute in some embodiments. The five-diaphragm cup configuration also decouples harmonic modes and reduces resonance overlap between the motor 315, 1315, 2315 and the cups 412, 1412, 2412 relative to a four-diaphragm cup configuration. Finally, due to more frequent air pulses per revolution provided by the five-diaphragm cup configuration, the check valves 510, 1501, 2501 tend to remain open during pumping, reducing valve noise.

In addition to the advantages provided by the five-diaphragm cup configuration, the wall structures of the upper casing 101, 1101, 2101 and the lower casing 102, 1102, 2102 dampen sounds of internal moving parts (e.g., the motor, wobble plate, cups, solenoids, etc.). Furthermore, the passageways (e.g., 407, 409, 103, etc.) along which the airflow AF travels are preferably airtight to inhibit leakage out of the pump assembly 100, 1100, 2100. Thus, sound from the pump assembly 100, 1100, 2100 due to hissing air and moving parts is reduced.

For example, the pump assembly 100 was tested in a standard vehicle seat to inflate and deflate two bladders of a pneumatic lumbar system. The seat was located in a noise isolation room at an ambient temperature of about 23 degrees Celsius and fitted with full trim. The pump assembly 100 was powered by a power supply having a voltage of 13.0V+0.2V. The vehicle seat was loaded with an adult male mannequin weighing 75 kilograms, and a microphone was placed about 600 millimeters from the head position of the mannequin. The pump assembly 100 was mounted to the seat frame inside the vehicle seat.

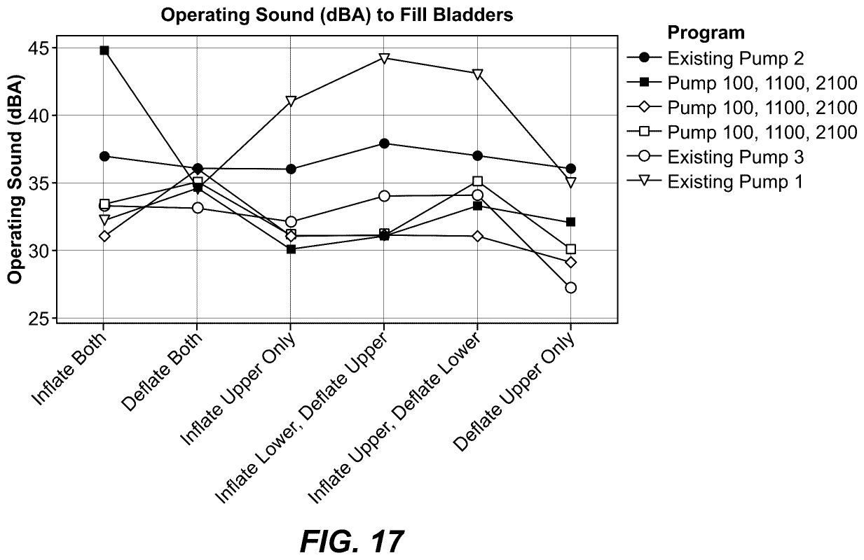

During testing, the two lumbar bladders were fully inflated and then fully deflated at the same time. Then, the bladders were inflated and deflated in an alternating manner. This inflation and deflation cycle was repeated three times for the tested pump assembly 100. The same test was then repeated with three existing pumps for comparison purposes. The testing cycling is illustrated in FIG. 17.

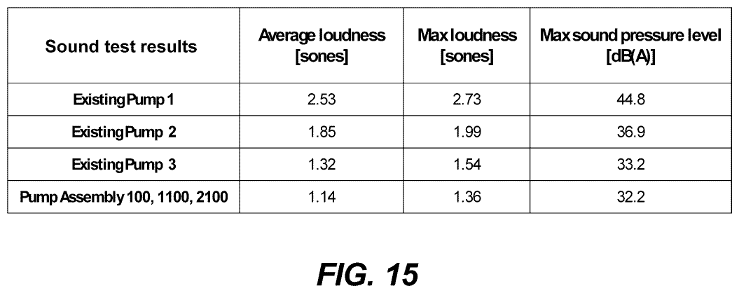

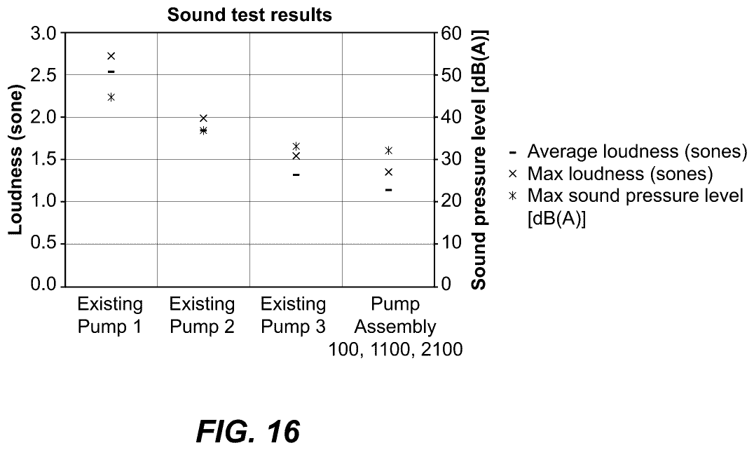

As shown in FIGS. 15-16, the pump assembly 100 operates at an average loudness between approximately 1.1 sones and approximately 1.2 sones. Specifically, the pump assembly 100 operates at an average loudness of approximately 1.14 sones. In contrast, existing pumps operate at an average loudness between approximately 1.3 sones to approximately 2.6 sones. Thus, the pump assembly 100 was observed to be an average of about 14% quieter than the next quietest tested existing pump.

As shown in FIGS. 15-16, the pump assembly 100 similarly operates at a max sound pressure level between approximately 32.1 dB (A) and approximately 32.5 dB (A). Specifically, the pump assembly 100 similarly operates at a max sound pressure level of approximately 32.2 dB (A). In contrast, existing pumps operate at a max sound pressure level between approximately 33.2 dB (A) and approximately 44.8 dB (A).

As shown in FIG. 17, the pump assembly 100 consistently operates at a lower sound (dBA) in various stages or inflating and deflating the bladders 205a (1205a), 205b (1205b), 1205c, 1205d. The three lines (square dark, square light, and diamond) represent three separate tests of the pump assembly 100 operating to inflate both bladders, deflate both bladders, inflate upper bladder only, inflate lower (while deflating upper), inflate upper (while deflating lower), and deflate upper only.

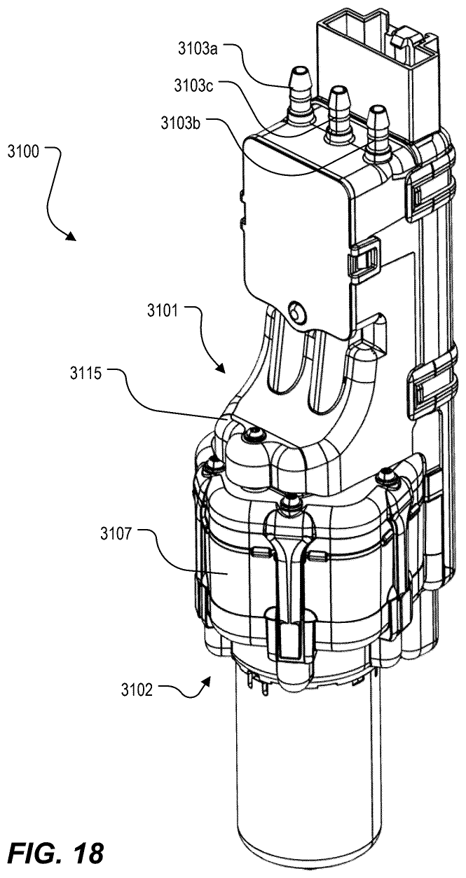

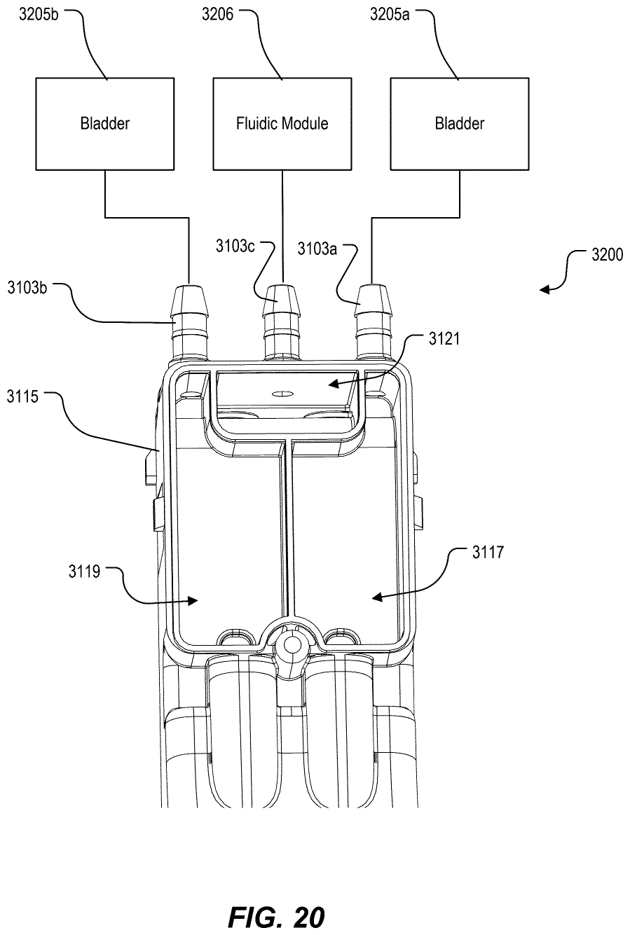

FIGS. 18-24 illustrate a pump assembly 3100 according to another embodiment. The pump assembly 3100 is similar to the pump assembly 100 described above with reference to FIGS. 1-6, and features and elements of the pump assembly 3100 corresponding with features and elements of the pump assembly 100 are given identical reference numbers plus 3000. In addition, the following description focuses primarily on differences between the pump assembly 3100 and the pump assembly 100. As illustrated in FIG. 20, the pump assembly 3100 may also be part of a pneumatic system 3200, similar to the pneumatic system 200 described above with reference to FIG. 2.

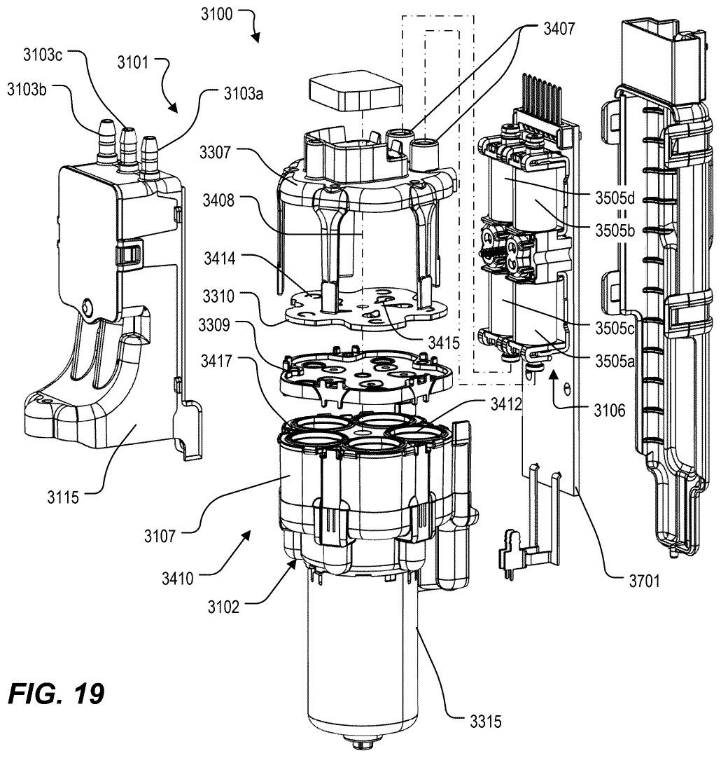

FIG. 19 illustrates an exploded view of the pump assembly 3100. The pump assembly 3100 extends along a longitudinal axis 3408 and includes an upper casing 3101, a lower casing 3102, and a pump housing 3107 between the upper and lower casings 3101, 3102. The upper casing 3101 includes a plurality of outlet ports (three ports 3103a-c in the illustrated embodiment). The illustrated pump assembly 3100 further includes a head plate 3309 and a valve plate 3310 positioned between the upper casing 3101 and the lower casing 3102 and, more specifically, between the pump housing 3107 and the upper casing 3101. A diaphragm assembly 3417, which forms part of a pneumatic pump 3410, is clamped between the head plate 3309 and the pump housing 3107.

The valve plate 3310 includes a plurality of air intake valves 3414 and a plurality of air outlet valves 3415 to control the airflow AF into and out of the diaphragm assembly 3417, as the diaphragm assembly 3417 is sequentially compressed and expanded during operation of the pneumatic pump 3410. One air intake valve 3414 and one air outlet valve 3415 is aligned with each respective diaphragm cup 3412 of the diaphragm assembly 3417.

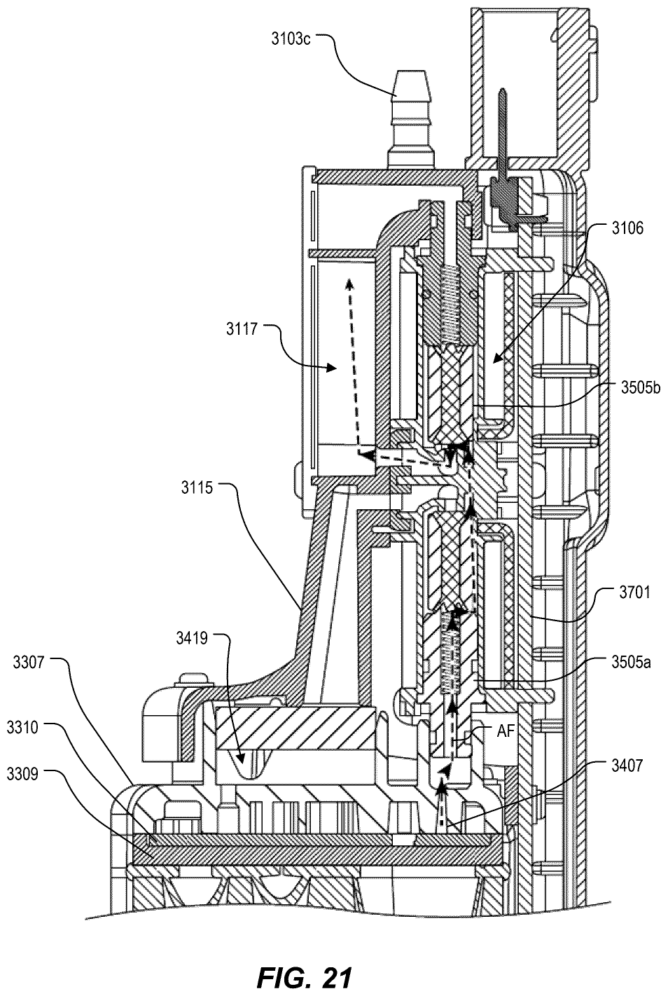

The upper casing 3101 includes an outlet plate 3307 positioned adjacent to the valve plate 3310 and a valve assembly housing 3115 coupled to the outlet plate 3307 (FIG. 21). The outlet plate 3307 includes passages for communicating each of the air intake valves 3414 with an air intake 3419 of the pneumatic pump 3410 and passages for communicating each of the air outlet valves 3415 with a pair of outlets 3407. As shown in FIG. 20, the valve assembly housing 3115 includes a first chamber 3117 in fluid communication with the first outlet port 3103a, a second chamber 3119 in fluid communication with the second outlet port 3103b, and a third chamber 3121 in fluid communication with the third outlet port 3103c.

With continued reference to FIG. 20, the pneumatic system 3200 includes two pneumatic bladders 2505a, 2505b coupled to the respective first and second outlet ports 3101a, 3103b (e.g., via suitable pneumatic lines). The pneumatic bladders 2505a, 2505b may be positioned, for example, in lumbar or bolster regions of a vehicle seat to provide the lumbar or bolsters with adjustable firmness. The pneumatic system 3200 may also include a pneumatic device, such as a fluidic module 3206, coupled to the third outlet port 3103c (e.g., via a suitable pneumatic line). In the illustrated embodiment, the third outlet port 3103c is disposed between the first and second outlet ports 3103a, 3103b.

The fluidic module 3206 may be, for example, any of the fluidic modules disclosed in U.S. Pat. No. 11,883,358, assigned to Leggett & Platt Canada Co., the entire content of which is incorporated herein by reference. The fluidic module 3206 may feed air to multiple additional pneumatic bladders and provide an air switching function to inflate and deflate the additional pneumatic bladders in a desired sequence, thereby providing a massage function. The fluidic module 3206 may alternatively include an external valve module for inflating and deflating the additional pneumatic bladders. As described in greater detail below, the valve assembly 3106 of the pneumatic pump 3410 is able to direct two parallel air flows to the first and second outlet ports 3103a, 3103b, or to combine those two air flows to supply a greater volume of air to the third outlet port 3103c, which can then provide a more effective massage.

Referring again to FIG. 19, the valve assembly 3106 at least partially received within the valve assembly housing 3115, such that the pump assembly 3100 and the valve assembly 3106 define an integrated pump and valve system. The illustrated valve assembly 3106 includes a plurality of (e.g., four) control valves 3505a-d. Unlike the valve assemblies associated with the pump assemblies 100, 1100, 2100, however, the valve assembly 3106 does not include check valves between the outlets 3407 and the control valves 3505a-d.

The illustrated valve assembly 3106 includes two pairs of control valves for a total of four control valves 3505a, 3505b, 3505c, 3505d. As described in greater detail below, the control valves 3505a, 3505c provide inflation and deflation control, and the control valves 3505b, 3505d provide port selection (directional) control. That is, the control valves 3505b, 3505d select which of the outlet ports 3103a-c are fluidly connected to the pump assembly 3100, and the control valves 3505a, 3505c control whether pressurized air is supplied to or exhausted from the selected outlet ports 3103a-c.

In the illustrated embodiment, the pair of control valves 3505a, 3505b is arranged in parallel with respect to the other pair of control valves 3505c, 3505d (not in series). That is, the individual control valves comprising each pair of valves are arranged in series such that control valves 3505a, 3505b are arranged in series with each other and the control valves 3505c, 3505d are arranged in series with each other. As such, air generated from the diaphragm cups 3412 can pass simultaneously and independently through each pair of control valves.

The control valves 3505a, 3505b, 3505c, 3505d are oriented parallel to the longitudinal axis 3408 and connected to a PCB 3701, which also extends parallel to the longitudinal axis 3408. Like the PCB 701, the PCB 3701 is also connected to the motor 3315 of the pump assembly 3100. Each control valve 3505a-3505d is a 3/2-way pneumatic directional control valve in the illustrated embodiment, such as a solenoid-actuated control valve. In other embodiments, other types of valves may be used.

Operation of the pump assembly 3100 and pneumatic system 3200 will now be described with reference to FIGS. 20-24. In operation, to inflate the first pneumatic bladder 3205a connected to the first outlet port 3103a, the motor 3315 is energized (e.g., via the PCB 3701) to sequentially compress and expand the diaphragms 3412. During expansion, each diaphragm 3412 draws air from the air intake 3419 and through the corresponding air intake valve 3414. In the illustrated embodiment, a filter 3421 (e.g., an open cell foam filter) is provided adjacent the air intake 3419 to remove potential dust or debris from the incoming air and also to reduce the noise associated with the flowing air. As each diaphragm 3412 is compressed, air is forced out through the corresponding air outlet valve 3415 and routed to the outlet 3407 by passages (not shown) in the outlet plate 3307. As shown in FIG. 21, to inflate the first bladder 3205a, the first control valve 3505a remains in its unenergized position, allowing an airflow AF to flow from the outlet 3407, through the first control valve 3505a, and to the second control valve 3505b. The second control valve 3505b is actuated to its energized position, allowing the airflow AF to enter the first chamber 3117. The airflow AF can then flow from the first chamber 3117 to the first outlet port 3103a and inflate the bladder 3205a (FIG. 20).

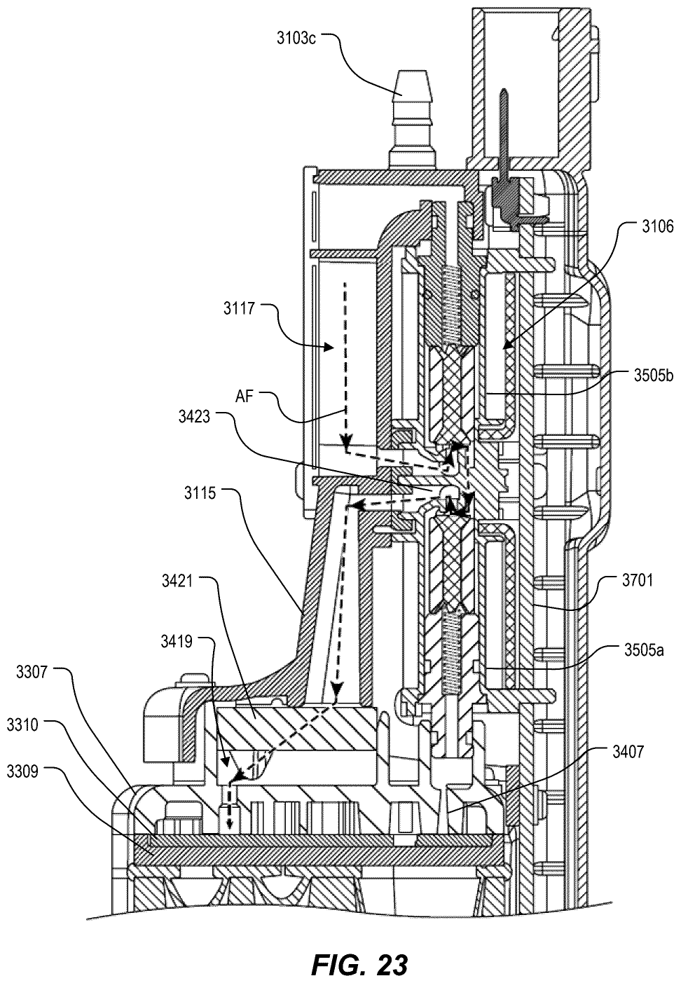

With reference to FIG. 23, to deflate the first pneumatic bladder 3205a, both the first and second control valves 3505a, 3505b are energized. This allows an airflow AF from the bladder 3205a to flow from the first chamber 3117, past the second control valve 3505b, and to the first control valve 3505a, which, when energized, opens an exhaust port 3423. The exhaust port 3423 routes the airflow AF back to the air intake 3419 for recirculation and through the filter 3421 to reduce noise. The air intake 3419 is also in communication with the surrounding environment, so any excess pressure at the air intake 3419 may be vented to the environment.

Inflation and deflation of the second pneumatic bladder 3205b is performed in the same way as the first pneumatic bladder 3205a, but using the third and fourth control valves 3505c, 3505d instead of the first and second control valves 3505a, 3505b.

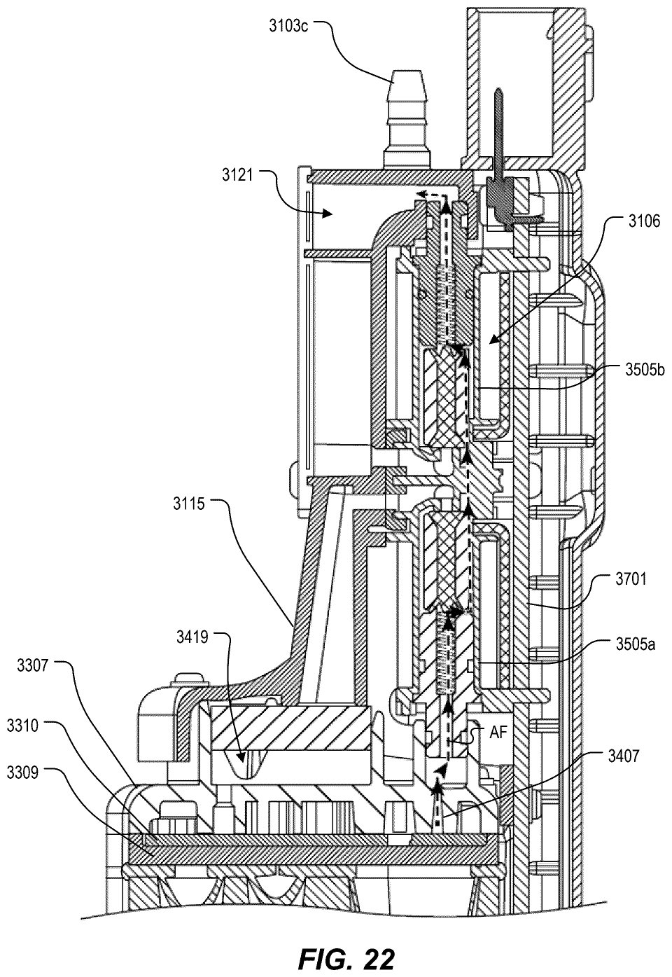

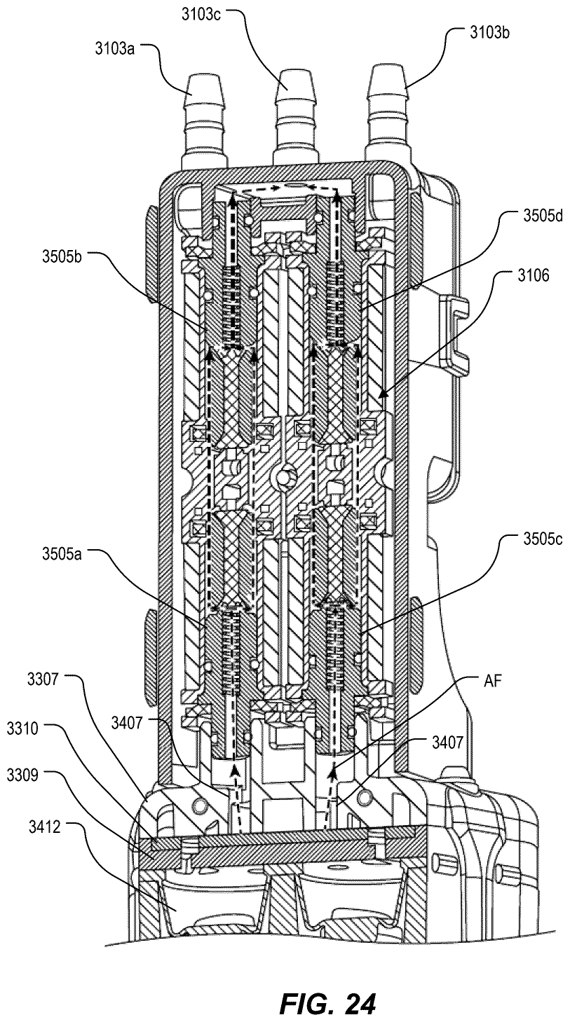

Finally, the illustrated pump assembly 3100 can also be operated to deliver an airflow AF to the fluidic module 3206 (FIG. 20), or any other bladder or device connected to the third outlet port 3103c. The volume of the airflow AF delivered to the third outlet port 310c may be greater than the volume of the airflow AF delivered to either the first or second bladder ports 3103a, 3103b. As shown in FIG. 24, with all of the control valves in their de-energized positions, the generated airflow AF flows in two parallel streams, through each pair of control valves 3505a, 3505b, 3505c, 3505d. The airflow AF then combines and flows into the third chamber 3121 (FIGS. 20 and 22). The valve assembly 3106 thus assumes a pass-through configuration when all of the control valves 3505a-d are de-energized, allowing the entire output of the pump assembly 3100 to be routed to the third outlet port 3103c and providing a sufficient volume of air to operate the connected fluidic module 3206. In some embodiments, the pump assembly 3100 may have a free flow rate (with no connected bladders) of 3-6 liters, or at least 4 liters per minute in some embodiments.

### Representative Features

Representative features are set out in the following clauses, which stand alone or may be combined, in any combination, with one or more features disclosed in the text and/or drawings of the specification.
Clause 1. A pump assembly comprising: a housing including a plurality of outlet ports; a motor extending along a longitudinal axis; a pneumatic pump driven by the motor; a valve assembly downstream of the pneumatic pump and in fluid communication with the plurality of outlet ports, the valve assembly configured to selectively direct an airflow generated by the pneumatic pump to the plurality of outlet ports; a printed circuit board supported by the housing and electrically connected to the motor and the valve assembly, wherein the printed circuit board extends parallel to the longitudinal axis.
Clause 2. The pump assembly of clause 1, wherein the plurality of outlet ports includes at least three outlet ports, and wherein the valve assembly includes at least three valves.
Clause 3. The pump assembly of clause 1, wherein the printed circuit board extends continuously from the motor to the valve assembly.
Clause 4. The pump assembly of clause 1, wherein the housing includes a lower casing coupled to the motor, an upper casing including the plurality of outlet ports, and a PCB housing coupled to the upper casing and at least partially enclosing the printed circuit board.
Clause 5. The pump assembly of clause 4, wherein the upper casing at least partially encloses the valve assembly, wherein the pneumatic pump includes a diaphragm assembly and a valve plate including a plurality of air intake valves and a plurality of air outlet valves, and wherein the upper casing includes an outlet in communication with the plurality of air outlet valves and the valve assembly.
Clause 6. The pump assembly of clause 5, wherein the valve assembly includes a check valve and a directional control valve downstream of the check valve, the check valve including a valve body and a spring biasing the valve body to close the outlet.
Clause 7. The pump assembly of clause 6, wherein the check valve is oriented parallel to the longitudinal axis.
Clause 8. The pump assembly of clause 7, wherein the check valve is one of a plurality of check valves.
Clause 9. The pump assembly of clause 1, wherein the valve assembly includes a plurality of control valves oriented parallel to the longitudinal axis.
Clause 10. The pump assembly of clause 1, wherein the pneumatic pump includes a diaphragm assembly having five chambers that are sequentially expanded and compressed in response to the motor being activated.
Clause 11. The pump assembly of clause 1, wherein the pump assembly is configured to output an airflow at a free flow rate between 3-6 liters per minute.
Clause 12. The pump assembly of clause 1, wherein the pump assembly is operable at a maximum loudness between 1.1 sones and 1.2 sones.
Clause 13. A pump assembly comprising: a housing including a plurality of outlet ports; a motor extending along a longitudinal axis; a pneumatic pump driven by the motor; a valve assembly downstream of the pneumatic pump and in fluid communication with the plurality of outlet ports, the valve assembly configured to selectively direct an airflow generated by the pneumatic pump to the plurality of outlet ports; a printed circuit board supported by the housing and electrically connected to the motor and the valve assembly, wherein pump assembly is configured to output an airflow at a free flow rate between 3-6 liters per minute, and wherein the pump assembly is operable at a maximum loudness between 1.1 sones and 1.2 sones.
Clause 14. The pump assembly of clause 13, wherein the pneumatic pump includes a diaphragm assembly having five diaphragm chambers.
Clause 15. A pump assembly comprising: a housing including a plurality of outlet ports; a motor extending along a longitudinal axis; a pneumatic pump driven by the motor; a valve assembly downstream of the pneumatic pump and in fluid communication with the plurality of outlet ports, the valve assembly configured to selectively direct an airflow generated by the pneumatic pump to the plurality of outlet ports; and a printed circuit board supported by the housing and electrically connected to the motor and the valve assembly, wherein the valve assembly includes a first control valve, a second control valve arranged in series with the first control valve, a third control valve arranged in parallel with the first and second control valves, and a fourth control valve arranged in series with the third control valve.
Clause 16. The pump assembly of clause 15, wherein the first, second, third, and fourth control valves are 3/2-way solenoid actuated valves.
Clause 17. The pump assembly of clause 15, wherein the plurality of outlet ports includes a first outlet port, a second outlet port, and a third outlet port.
Clause 18. The pump assembly of clause 17, wherein an airflow generated by the pneumatic pump is routed to the third outlet port by the valve assembly when the first control valve, the second control valve, the third control valve, and the fourth control valve are de-energized.
Clause 19. The pump assembly of clause 15, wherein the first control valve and the third control valve are configured to selectively connect the plurality of outlet ports to an exhaust port.
Clause 20. The pump assembly of clause 19, wherein the exhaust port fluidly communicates with an air intake of the pneumatic pump.

Various features and aspects of the present disclosure are set forth in the following claims.

What is claimed is:

1. A pump assembly comprising:
a housing including a plurality of outlet ports;
a motor extending along a longitudinal axis;
a pneumatic pump driven by the motor;
a valve assembly downstream of the pneumatic pump and in fluid communication with the plurality of outlet ports, the valve assembly configured to selectively direct an airflow generated by the pneumatic pump to the plurality of outlet ports;
a printed circuit board supported by the housing and electrically connected to the motor and the valve assembly,
wherein the printed circuit board extends parallel to the longitudinal axis.

2. The pump assembly of claim 1, wherein the plurality of outlet ports includes at least three outlet ports, and wherein the valve assembly includes at least three valves.

3. The pump assembly of claim 1, wherein the printed circuit board extends continuously from the motor to the valve assembly.

4. The pump assembly of claim 1, wherein the housing includes a lower casing coupled to the motor, an upper casing including the plurality of outlet ports, and a PCB housing coupled to the upper casing and at least partially enclosing the printed circuit board.

5. The pump assembly of claim 4, wherein the upper casing at least partially encloses the valve assembly, wherein the pneumatic pump includes a diaphragm assembly and a valve plate including a plurality of air intake valves and a plurality of air outlet valves, and wherein the upper casing includes an outlet in communication with the plurality of air outlet valves and the valve assembly.

6. The pump assembly of claim 5, wherein the valve assembly includes a check valve and a directional control valve downstream of the check valve, the check valve including a valve body and a spring biasing the valve body to close the outlet.

7. The pump assembly of claim 6, wherein the check valve is oriented parallel to the longitudinal axis.

8. The pump assembly of claim 7, wherein the check valve is one of a plurality of check valves.

9. The pump assembly of claim 1, wherein the valve assembly includes a plurality of control valves oriented parallel to the longitudinal axis.

10. The pump assembly of claim 1, wherein the pneumatic pump includes a diaphragm assembly having five chambers that are sequentially expanded and compressed in response to the motor being activated.

11. The pump assembly of claim 1, wherein the pump assembly is configured to output an airflow at a free flow rate between 3-6 liters per minute.

12. The pump assembly of claim 1, wherein the pump assembly is operable at a maximum loudness between 1.1 sones and 1.2 sones.

13. A pump assembly comprising:
a housing including a plurality of outlet ports;
a motor extending along a longitudinal axis;
a pneumatic pump driven by the motor;
a valve assembly downstream of the pneumatic pump and in fluid communication with the plurality of outlet ports, the valve assembly configured to selectively direct an airflow generated by the pneumatic pump to the plurality of outlet ports;
a printed circuit board supported by the housing and electrically connected to the motor and the valve assembly,
wherein pump assembly is configured to output an airflow at a free flow rate between 3-6 liters per minute, and
wherein the pump assembly is operable at a maximum loudness between 1.1 sones and 1.2 sones.

14. The pump assembly of claim 13, wherein the pneumatic pump includes a diaphragm assembly having five diaphragm chambers.

15. A pump assembly comprising:
a housing including a plurality of outlet ports;
a motor extending along a longitudinal axis;
a pneumatic pump driven by the motor;
a valve assembly downstream of the pneumatic pump and in fluid communication with the plurality of outlet ports, the valve assembly configured to selectively direct an airflow generated by the pneumatic pump to the plurality of outlet ports; and
a printed circuit board supported by the housing and electrically connected to the motor and the valve assembly,
wherein the valve assembly includes a first control valve, a second control valve arranged in series with the first control valve, a third control valve arranged in parallel with the first and second control valves, and a fourth control valve arranged in series with the third control valve.

16. The pump assembly of claim 15, wherein the first, second, third, and fourth control valves are 3/2-way solenoid actuated valves.

17. The pump assembly of claim 15, wherein the plurality of outlet ports includes a first outlet port, a second outlet port, and a third outlet port.

18. The pump assembly of claim 17, wherein an airflow generated by the pneumatic pump is routed to the third outlet port by the valve assembly when the first control valve, the second control valve, the third control valve, and the fourth control valve are de-energized.

19. The pump assembly of claim 15, wherein the first control valve and the third control valve are configured to selectively connect the plurality of outlet ports to an exhaust port.

20. The pump assembly of claim 19, wherein the exhaust port fluidly communicates with an air intake of the pneumatic pump.
